(19) United States
(12) Patent Application Publication
(10) Pub. No.: US 2003/0123651 A1
(43) Pub. Date: Jul. 3, 2003

(54) ADSL business-card type network interface card

(76) Inventor: Sheng-feng Chung, Hsinchu (TW)

Correspondence Address: PERKINS COIE LLP, PATENT-SEA, P.O. BOX 1247, SEATTLE, WA, 98111-1247, US

(21) Appl. No.: 10/086,601

(22) Filed: Feb. 28, 2002

(30) Foreign Application Priority Data
Dec. 28, 2001 (TW) 90132972

(51) Int. Cl. H04M 1/00; H04M 9/00

(52) U.S. Cl. 379/413.02

(57) ABSTRACT

The present invention includes cardbus interface for DSP (digital signal processing) and for controlling the 32-bits information transmission DSP (digital signal processor) is connected to the cardbus interface to process the digital signal. D/A converter is connected to the DSP to transform the digital signal to analog signal. A transmitter amplify is coupled to the D/A converter to amplify the transformed signal. A multi-level filter is connected to the A/D converter via one terminal. The bandwidth of the multi-level filter is about 24K to 1M. The transmitter amplify is coupled to a protection circuit consisting of current protector 152, bias protector, lightning protector and high voltage to low voltage transformer. A phone jack is connected to the protection circuit for plugging the transmission line to communicate to outside.

### FIELD OF THE INVENTION

The present invention relates to a network interface card for portable computer or device, and more specifically, to a ADSL network interface card.

### BACKGROUND OF THE INVENTION

Along with the rapid development of electronic industry, the devices are manufactured with small size and multi-functions. PCMCIA (personal computer memory card international association) is common used and implanted in the portable computer for communication. In general, the PCMCIA card is inserted into a slot of the computer and the PCMCIA card includes the MODEM function and network communication function for communicating with the remote terminals. As know in the art, the MODEM may transform the binary information into analog signal for transmitting the data via the phone lines. U.S. Pat. No. 5,373,149 to Rasmussen and assigned to AT&T Bell Laboratories, disclosed a PCMCIA wireless credit card modem fabricated using two credit card sized sections interconnected by a hinge. The first section contains modem circuitry, and the second section contains an antenna and radio circuitry. The two sections form a 90 degree angle in the open position. The section with the modem circuitry fits into a type I or II PCMCIA slot in a portable computer, and the section with the antenna remains on the outside of the computer.

As long with the carried information increased, the facing challenge is the bandwidth. The PCMCIA can not meet the requirement for present. The protocol of the asymmetrical digital subscriber line (ADSL) is the so-call discrete multi-tone signaling (DMIT) protocol. A great amount of the desk top computer is couple to the network by using the type of ADSL. The ADSL may provide wider bandwidth and higher speed for downloading information. Up to now, the portable device including notebook computer cannot connect to the network by using the ADSL. Thus, the present invention provides means for connecting network using ADSL.

### SUMMARY OF THE INVENTION

The object of the present invention is to disclose a device for connecting to the network for the portable device including computer by using ADSL protocol.

The further object of the present invention is to provide 32-bits ADSL network interface card having cardbus interface, multi-level filter and lightning protector.

The present invention includes cardbus interface for DSP (digital signal processing) and for controlling the 32-bits information transmission. DSP (digital signal processor) is connected to the cardbus interface to process the digital signal. D/A converter is connected to the DSP to transform the digital signal to analog signal. A transmitter amplify is coupled to the D/A converter to amplify the transformed signal. A multi-level filter is connected to the A/D converter via one terminal. The bandwidth of the multi-level filter is about 24K to 1M. The transmitter amplify is coupled to a protection circuit consisting of current protector 152, bias protector, lightning protector and high voltage to low voltage transformer. A phone jack is connected to the protection circuit for plugging the transmission line to communicate to outside.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is scheme illustrating the functional diagram according to the present invention.

### THE DETAILED DESCRIPTION OF THE PREFERRED EMBODIMENT

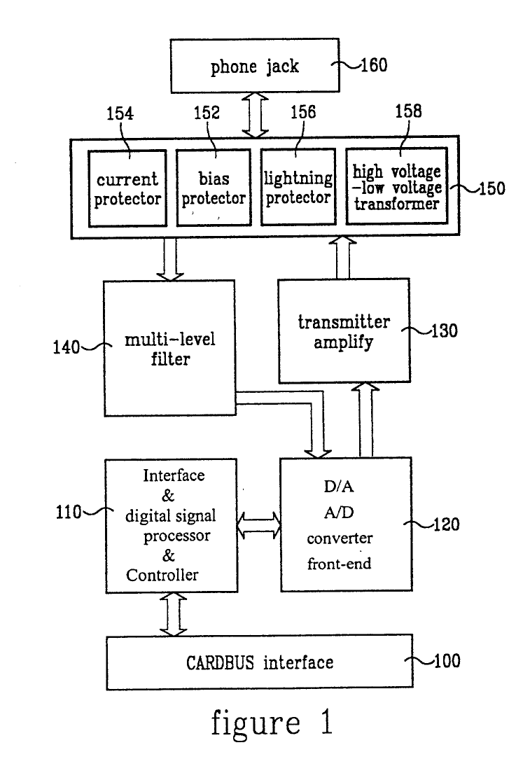

Turning to FIG. 1, the present invention includes cardbus interface 100 for DSP (digital signal processing) and for controlling the 32-bits information transmission. The former art used PCI bus that is not available for the cardbus interface. DSP (digital signal processor) 110 is connected to the cardbus interface 100 to process the digital signal. In one embodiment, the type of 90388 chip may be used and packed by TQFP type package. As know in the art, it is only for an example rather than limiting the present invention.

D/A converter 120 is connected to the DSP 120 to transform the digital signal to analog signal. A transmitter amplify 130 is coupled to the D/A converter 120 to amplify the transformed signal. In one embodiment, the type of EL 1510 amplify may be used for an example.

A multi-level filter 140 is connected to the A/D converter 120 via one terminal. The bandwidth of the multi-level filter 140 is about 24K to 1M. Preferably, the three-level filter may be used for the preferred embodiment. The multi-level filter 140 is consisted of plurality of the resistor, capacitor and inductance and these elements form a band pass filter to select the wanted signal. The heights of the elements are within the standard of the cardbus. The position for allocating the elements and the ground pad may influence the performance of the device. The tolerance of the inductance is less 5% and the tolerance of the capacitor is less than 2%.

The transmitter amplify 130 is coupled to a protection circuit 150 consisting of current protector 152, bias protector 154, lightning protector 156 and high voltage to low voltage transformer 158. A phone jack 160 is connected to the protection circuit 150 for plugging the transmission line to communicate to outside.

The signal of the portable device is transmitted to the DSP 110 by the cardbus interface 100 and transforms the digital signal to analog signal by using the D/A converter 120. The signal is amplified by the transmitter amplify 130, followed by feeding the signal to the protection circuit 150. The signal is transmitted via the phone jack 160 and the transmission line. The external information is download via the phone jack 160, the protection circuit 150. The input signal is processed by the multi-level filter 140, followed by inputting into the portable device via the A/D converter 120, DSP 110 and the cardbus interface 100.

The advantage of the present invention includes:

1. excellent EMC (EMI+EMS) protection effect. 2. the portable device may connect to the network by using ADSL protocol. 3. the present invention provides 32-bits ADSL network interface card having cardbus interface, multi-level filter and lightning protector.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

What is claimed is:

1. A network interface card, comprising:
cardbus interface for digital signal processing and controlling the information transmission;
DSP (digital signal processor) connected to said cardbus interface to process the digital signal;
D/A converter connected to said DSP to transform the digital signal to analog signal;
a transmitter amplify coupled to said D/A converter to amplify the transformed signal;
a multi-level filter connected to said A/D converter;
a protection circuit coupled to said transmitter amplify; and
a phone jack connected to said protection circuit for plugging a transmission line to communicate to outside.

2. The network interface card of claim 1, wherein said protection circuit includes current protector.

3. The network interface card of claim 1, wherein said protection circuit includes bias protector.

4. The network interface card of claim 1, wherein said protection circuit includes lightning protector.

5. The network interface card of claim 1, wherein said protection circuit includes high voltage to low voltage transformer.

6. The network interface card of claim 1, wherein said multi-level filter includes three-level filter.
